(19) United States
(12) Patent Application Publication
(10) Pub. No.: US 2002/0013827 A1
(43) Pub. Date: Jan. 31, 2002

(54) Personal service environment management apparatus and methods

(76) Inventors: Claes G.R. Edstrom, Hagersten (SE); Ulf C.G. Brandstrom, Taby (SE); Bo A.V. Astrom, Hagersten (SE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 09/860,185

(22) Filed: May 17, 2001

Related U.S. Application Data
(60) Provisional application No. 60/205,316, filed on May 18, 2000.
(60) Provisional application No. 60/205,816, filed on May 19, 2000.

(51) Int. Cl. G06F 15/16

(52) U.S. Cl. 709/219; 709/218; 345/744

(57) ABSTRACT

A Service Network and Personal Service Environment Manager host and manage functionality shared among applications and user groups to provide common, application-independent directory services that serve as a logically central point of access to data. In particular, end-users can manage their service profiles in access- and location-independent scenarios. The PSEM includes functions for providing and managing service data, end-user profile data, and end-user service profile data. Among others, important aspects of the PSEM are its interfaces to other entities and functions, its distinguishing between user profile data and service-related data (i.e., service profile data and service data), and its further distinguishing between service profile data and service data.

### CROSS-REFERENCE TO A RELATED APPLICATIONS

This application is related to and claims priority under 35 U.S.C. § 119(e) to U.S. Provisional Applications No. 60/205,316 and No. 60/205,816 entitled “Personal Service Environment Manager (PSEM)” filed on May 18, 2000, and May 19, 2000, respectively. These applications are incorporated here by reference.

### BACKGROUND

This application relates to electronic communication systems and in particular to management of data in such systems.

The mobile Internet combines the power of the Internet with the convenience of mobility. Instead of connecting a personal computer to a telephone line or finding an Internet cafe, anyone with a mobile phone can access the Internet or other online information anytime, anywhere. But the mobile Internet means more than giving mobile access to the Internet. It is more personal, enabling access to services that are based on personal preferences, location, and current circumstances. In particular, the mobile Internet offers services that are relevant in a mobile environment, that can be efficiently and neatly presented and used in this environment, that have critical factors that are location-based, that provide immediacy of reach and response, and that offer the same basic service set and profile data in all access environments, even if they are presented and sometimes executed differently.

An important aspect of such communication systems is that the terminal is closely tied to the individual user: terminals are normally switched on and stay with users wherever they go. Users can thus send and receive e-mail instantly wherever they are. News can be “pushed” to users as it occurs. Localized Yellow Pages or street maps can be immediately available. A mobile terminal also enables secure transactions for online payments, banking, and stock trading.

Eventually the mobile terminal will be just one means of accessing the Internet, which may become the home of applications for fixed and mobile users. The ability to personalize information by building up individual user profiles and then targeting information to specific individuals will be a key factor in the success of the mobile Internet and following telecommunication systems.

Telecommunication systems have been vertically integrated, with applications and services closely tied to the delivery channel, e.g., a cellular radiotelephone channel, a real circuit in a fixed circuit-switched network, or a virtual circuit in a packet-switched network. In the area of the end-user services and applications in mobile telecommunication networks, today's second-generation (“2G”) access networks such as those complying with the Global System for Mobile (“GSM”) standard, the U.S. time-division-multiple-access (“TDMA”) standard TIA/EIA/IS-136, the code-division-multiple-access (“CDMA”) standard TIA/EIA/IS-95, and their improvements have implemented most services in core network nodes, e.g., the home location register (“HLR”) and the visitor location register (“VLR”) usually provided in the mobile switching center (“MSC”). Today's vertically segmented networks also have their own operation and maintenance systems, their own customer databases, etc.

In today's networks, an application-specific database or directory stores typically only information that is a needed by one particular application or service, and the database/directory is not accessible to other applications/services. In addition, these database/directory services are usually limited in search capabilities, storage capabilities, administration tools, and physical/logical location. In such an environment each function stores and manages its own data. Thus, if one wants to arrange a trip to Paris, one might book tickets by logging on to a ticketing application with one's username and password. If one wants directions to the terminal/airport, one would log on to a separate location-based service application, and then if one wants to send e-mail to a companion, one would log on again to a messaging application. This process is neither user-friendly nor efficient, resulting from non-uniform management and provision of services and applications, which makes global access to a set of Internet-based services difficult.

The traditional vertical network segmentation is beginning to change to a horizontal segmentation, in which almost any application or service can be provided over any underlying communication network. In such horizontally segmented networks, user terminals, infrastructure, and applications can be less closely tied together. User applications typically include a client part in the terminal and a server part in the network, communicating over preferably open interfaces to a network that is application-independent. Terminals and client-parts of applications still must be tightly tied to server-parts of applications, and this new client-server architecture still needs close coordination between user terminals and the various network layers. On the other hand, access to the network of services is no longer closely tied to the applications. Services implemented by applications running on application servers can be reached through any access network and from any terminal. Necessary terminal adjustments are part of the service network functionality, in particular the portal core or “portal engine” part of the service network, leaving the applications substantially unaffected by the terminals.

For third-generation (“3G”) access networks like the Universal Mobile Telephone Service (“UMTS”), standardization bodies are working to open up the networks in the service area by introducing an open service architecture (“OSA”). Services will longer be standardized in the core network, but rather will be developed based on standardized service capabilities. The principles of such layered network architectures are being standardized by the Third-Generation Partnership Project (“3GPP”). These principles include an open service architecture (“OSA”) that enables service providers to use network functionality provided by service capability servers through an open-standard application program interface (“API”).

In particular, the 3GPP is trying to standardize a virtual home environment (“VHE”) and OSA that includes a personal service environment (“PSE”), in which an end-user is able to manage services from any location and any terminal. With the VHE concept for carrying a PSE across network boundaries and among terminals, end-users can be consistently presented with the same personalized features and customized user interface and services, regardless of their location or which network or terminal they use (within the capabilities of the terminal and network). The VHE and PSE are described in “The Virtual Home Environment (Release 5)”, 3GPP Technical Specification TS 22.121, ver. 5.0.0 (March 2001); “Stage 1 Service Requirement for the Open Service Access (OSA) (Release 4)”, Technical Specification TS 22.127, ver. 4.1.0 (March 2001); and “Virtual Home Environment (Release 4)”, 3GPP Technical Specification TS 23.127, ver. 4.1.0 (April 2001).

This architecture imposes requirements on the end-user service management functions and the interface that will enable the end user to access the PSE in a consistent and uniform manner. One of the aspects that must be considered is the use of directories and databases for storing and accessing information relevant to the end-user.

As shown in FIGS. 1A, 1B, a directory can be seen as a specialized database with characteristics that differentiate it from a general-purpose relational database. In FIG. 1A, an application communicates with a directory server using a convenient protocol, such as the lightweight directory access protocol (“LDAP”), and the directory server accesses the directory information. Also in FIG. 1A, an application communicates with a database engine using database queries that may be phrased in the structured query language (“SQL”), and the database engine manipulates information in a relational or other kind of database. FIG. 1B shows a more complex architecture, in which an application uses the LDAP for communication with a directory server, whose directory accesses are mapped via the directory/mapping layer to database queries, and those queries are presented to a database engine that manipulates information in a relational database.

The differences between a specialized database/directory and a general-purpose database can be summarized as follows: a directory is usually accessed much more often than it is updated, i.e., the read and search functions are used more frequently than the write function; and a directory typically does not support transactions (operations which have to be completed in total or not at all, e.g., banking operations), which decreases the complexity of a database. Most databases today support standardized SQL, but directories support simplified access protocols such as the Directory Access Protocol (“DAP”) and the LDAP, which are optimized for search and read operations.

An API defines the programming interface a particular programming language uses to access a service. Several APIs are available for database and directory applications as depicted by FIG. 2, which shows a layout of an LDAP directory (the LDAP Server and X.500 directory/database) that is accessed via a Secure Sockets Layer/Transport Layer Security (“SSL/TLS”), TCP/IP protocol stack. The APIs that might be used for such a directory include JDBC, which is a Java-language API for executing SQL statements; JDAP, which is a Java API for accessing directory access protocols that is designed specifically for accessing the LDAP; and JNDI, which is a Java API for accessing directory access protocols that is independent of any specific protocol, e.g., LDAP, NDS, NIS, etc., and that requires a service provider interface (“SPI”) to access a particular underlying directory service. The SPI is usually designed by the vendor of the directory service and is supplied as a Java class library. Other APIs that are available for database and directory applications are ODBC, which is a C-language API for executing SQL statements, and LDAP C, which is a C-language API enabling a C-language application to access directory access protocols that is designed specifically for accessing the LDAP.

A directory is usually accessed using a client/server model of communication as depicted in FIG. 3. An application that wants to read or write information in the directory does not access the directory directly. Instead, it calls an API that is associated with a directory client. This results in a request message being formatted and sent to a directory server that will access the directory. The result of the access is then sent back as a reply to the requesting application These messages may be formatted according to LDAP and exchanged according to the Transmission Control Protocol/Internet Protocol (“TCP/IP”). The client is not dependent on the implementation of the server, and the server can implement the directory however it chooses.

As depicted in FIG. 2, such Java-language APIs are the “hooks” that enable Java applications to access a database, such as an X.500 database, through transport layers that may include SSL running over an access network using TCP/IP. X.500 is a standard for directory services that is promulgated by the International Telecommunications Union (“ITU”) and the ISO/IEC. The latest version of the standard is dated 1993, but many current implementations still follow the 1988 version of the standard. X.500 (1988) and X.500 (1993) differ in several aspects, even though they remain compatible in the most important aspects: interconnection and interworking. The X.500 standard defines the information model used in the directory services and specifies that communication between the directory client and the directory server uses the DAP.

It will be understood that DAP and LDAP define a communication protocol, i.e., the transport and format of messages that a directory client uses to access information from a directory server. The DAP uses the Open Systems Interconnect (“OSI”) seven-layer protocol to operate, making it a complex protocol that provides a wide range of functionality. The LDAP was designed to be a simpler access protocol, making the directory available to a wider variety of machines and applications. Like the HyperText Transfer Protocol (“HTTP”) and the File Transfer Protocol (“FTP”), LDAP is likely to become an indispensable part of the Internet's protocol suite, which includes TCP/IP.

Accordingly, there is a need for methods and apparatus that efficiently enable applications to share functionality, preferably from a single interface, and that provide the flexibility, scalability and user-friendliness demanded by the fast-changing mobile Internet and similar communication systems.

### SUMMARY

The Service Network and Personal Service Environment Manager described in this application host and manage functionality shared among applications and user groups. Data management can be done with service implementation in many ways, for example according to the VHE/OSA concepts under development by 3GPP when a generic data storage system is available. The purpose of such generic data storage is to provide common, application-independent directory services that serve as a logically central point of access to data. In particular in a VHE/OSA, the PSE is constructed such that end-users can manage their service profiles in access- and location-independent scenarios. In order for end-users to manage the wide range of services provided by the Service Network, a strong and user-friendly interface is provided.

In one aspect of the invention, a personal service environment manager (“PSEM”) is provided for managing information relating to end-users of a communication network that includes at least one application server for providing at least one network service. The information includes end-user profile data and service-related data. The PSEM includes a PSEM core and a plurality of PSEM managers, and the PSEM core governs the managers for providing end-user authorization and authentication in the communication network, end-user interface proxies towards communication access devices, end-user service management, including service discovery, service provisioning, and service customization, and access and availability control of the at least one application server.

The managers may include a Logon Manager that handles the logon procedures enabling an end-user to access information relating to the end-user; an End-User Service Provisioning Manager that administers provision of services to end-users; a User Profile Manager that inserts, deletes, modifies, and reads end-user profile data in a common directory; a Presentation Proxies Manager that provides adjustable user interfaces to end-users; an Application/Service Discovery Manager that handles discovery of applications and services by interfacing to the at least one application server; and an End-User Service Data Manager that handles service-related data.

In another aspect of the invention, there is provided a service network that includes at least one application server for providing a respective service to end-users, a personal service environment manager (“PSEM”) that can exchange information with the at least one application server, a common user profile directory that is accessible to the personal service environment manager, and at least one service enabler in communication with the personal service environment manager. The PSEM mediates end-user authorization and authentication in the service network, end-user interface proxies towards service network access devices, end-user service management, including service discovery, service provisioning, and service customization, end-user access to the common user profile directory, and access and availability control of the at least one application server.

### BRIEF DESCRIPTION OF THE DRAWINGS

The objects, features, and advantages of Applicants' invention will be understood by reading this description in conjunction with the drawings, in which like components are identified by like reference characters and in which:

FIGS. 1A, 1B illustrate directory and database architectures;

FIG. 2 shows a layout of an LDAP directory and APIs;

FIG. 3 depicts a client/server model of directory access;

FIG. 4 depicts a Service Network architecture from a server point of view;

FIG. 5 depicts a customer data model in a network;

FIG. 6 depicts a centralized directory architecture;

FIG. 7 depicts accessing user profile data;

FIG. 8 depicts a distributed directory architecture;

FIGS. 9A, 9B depict directory replication;

FIG. 10 depicts directory partitioning;

FIG. 11 depicts directory partitioning and replication;

FIG. 12 depicts accessing service-related data;

FIG. 13 depicts CAS connections to an underlying core network through a mediation layer;

FIG. 14 depicts integrated CAS and Service Network;

FIG. 15 depicts separated CAS and Service Network;

FIG. 16 depicts a Personal Service Environment Manager;

FIG. 17 depicts accessing and managing user profile data and service profile data;

FIG. 18 depicts end-user service discovery/service provisioning;

FIG. 19 depicts a broker mode of operation of the Personal Service Environment Manager towards Application Servers for service profile data personalization;

FIG. 20 depicts a proxy mode of operation of the Personal Service Environment Manager towards Application Servers for service profile data personalization;

FIG. 21 depicts first-time registration in a UMTS network having a Personal Service Environment Manager;

FIGS. 22A, 22B depict service provisioning discovery in a UMTS network having a Personal Service Environment Manager;

FIG. 23 depicts a service execution in a UMTS network having a Personal Service Environment Manager; and

FIG. 24 depicts another service execution in a UMTS network having a Personal Service Environment Manager.

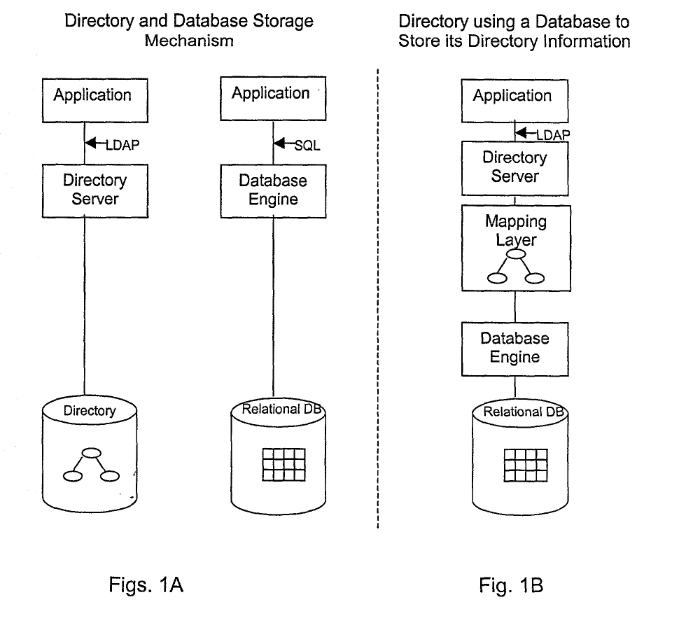

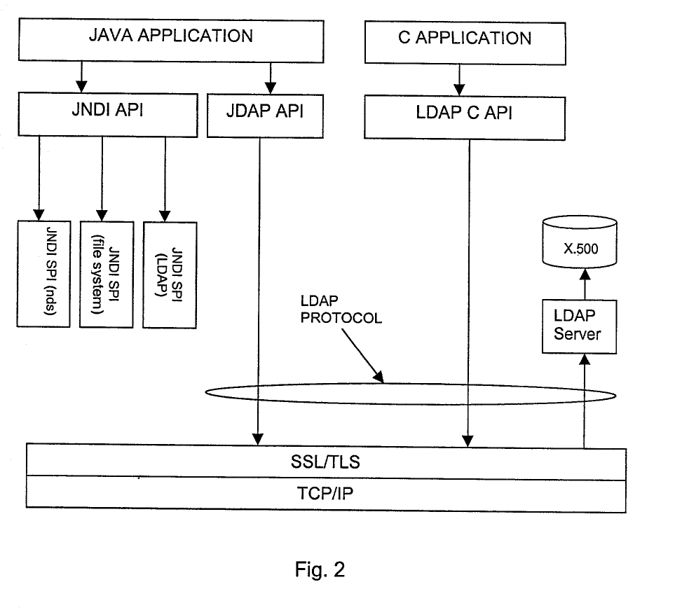

### DETAILED DESCRIPTION

The Personal Service Environment Manager described in this application facilitates implementation of a horizontally layered Service Network—one that separates applications and services from the access and core networks. In this way, the mobile Internet and other communications services, accessed by an end-user from any device and any access network, converge at the application level. The Service Network is thus a “melting pot” for all types of services and service combinations, giving end-users a personalized service environment, independent of access type.

It will be appreciated that this invention is applicable to any access network, such as public switched telephone networks (“PSTNs”); integrated services digital networks (“ISDNs”); cable networks; 2G, 2.5G, 3G mobile/cellular access networks; wireless local area networks (“LANs”), personal area networks (“PANs”), wide area networks (“WANs”); etc. Moreover, the independence of terminals and access networks can be used for portal solutions, Internet service provider (“ISP”) solutions, enterprise solutions, etc., as well as the horizontal service integration described in more detail below. It will also be appreciated that although end-user terminals are usually clients in this description, this invention is applicable in peer-to-peer architectures, which can be used for information push to “always connected” terminals for example.

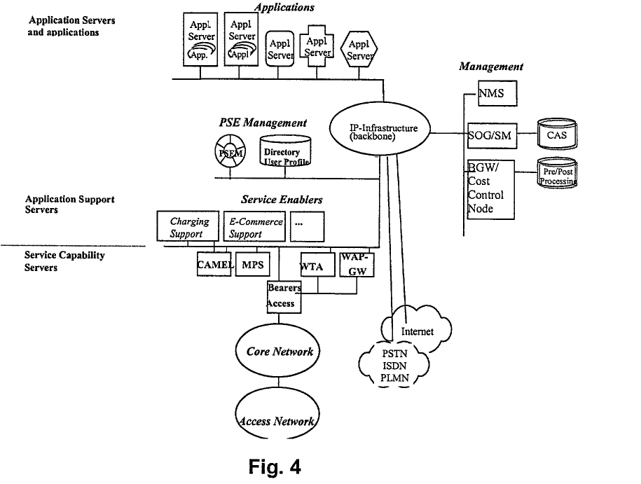

The Service Network, which is depicted from a server point of view in FIG. 4, handles four main interfaces. The first interface is to the core network and access network and is handled by one or more service enablers that include service capability servers (“SCSs”) and application support servers (“ASUSs”) and that are connected directly to the core network. The second interface enables end-users to administer their own services through a portal (a structured way of presenting services) that is a building block in a personal service environment management (“PSEM”) system. The PSEM stores personal information as end-user profiles, defines how services are provided and presented to end-users, and handles end-user service provisioning and service management, acting as the end-users' contact point for managing their own personal service environments. The third interface is to applications that typically reside on one or more Application Servers, at least some of which may be provided by independent developers. The final interface is the operator's management interface to operation and maintenance entities such as a network management system (“NMS), a service ordering gateway (“SOG”) interfacing with a service manager (“SM”), a billing gateway (“BGW”) interfacing with a cost control node, etc.

It is advantageous at least from cost and availability points of view for communication among these interfaces to occur through IP-based communication links. These links also efficiently connect these interfaces and functions together, regardless of end-user identity, application, network, terminal, time, or place. The Service Network advantageously comprises components integrated as an open architecture that enables applications and services (e.g., Application Servers) to be either loosely or tightly coupled with the Service Network.

Of the service enablers, the SCSs handle interworking with network components for services such as call control, user location, user status, message transfer, and terminal capabilities. The SCSs access specific Service Network resources, preferably through an open-standard API such as specified by the 3GPP. Examples of an SCS include a subscriber identity module (“SIM”) application toolkit and over-the-air (“OTA”) SIM card management system; a “Jambala” server, which may also be called a customized application for mobile network-enhanced logic (“CAMEL”) server, for intelligent network services, among other things, as described in F. Jones, “Jambala—Intelligence beyond Digital Wireless”, Ericsson Review vol. 75, no. 3, pp. 126-131 (1998), and A. Bertrand, “Jambala Mobility Gateway—Convergence and Inter-System Roaming”, Ericsson Review vol. 76, no. 2, pp. 89-93 (1999); a mobile execution environment (MExE), which includes a wireless application protocol (“WAP”) gateway and a wireless telephony application (“WTA”) server; a mobile positioning system (“MPS”) for location-based services such as that described in A. Johnston, T. Papanikolaou, and M. Slssingar, “The WISE Portal 2.0 Solution—Timely Delivery of Tailored Mobile Internet Services”, Ericsson Review vol. 78, no. 2, pp. 68-79 (2001)); and a home location register (“HLR”) gateway or mobile information gateway for end-user terminal status information. FIG. 4 shows the SCSs connecting to the core and access networks through a suitable bearer access interface.

The ASUSs interface with external resources and systems, such as billing, notification, and security systems, and provide system-wide support. In that role, ASUSs would not be connected to an application-specific function, e.g., charging for applications might be independent of the specific application. As depicted in FIG. 4, the ASUSs may include, among others, a charging server that hosts an authentication, authorization, and accounting (“AAA”) server and a service accounting gateway (“SAG”) server; notification support, which initiates “push” services and uses SCSs to “push” information to users via a short message service center (“SMS-C)” or a WAP gateway; security support, which has become more and more important, and may include Mobile e-Pay for e-commerce and m-commerce, a firewall, and public key infrastructure (“PKI”) for sensitive applications; directory support; and geo-navigation support, which adds value to positioning information, for example, by calculating the shortest walk to a specific destination.

To create an application, a developer may download the APIs needed to create the application, for example, for positioning, WAP, e- or m-commerce, or video streaming. When application development is complete, the developer can test it on a simulator or test site provided by the Service Network operator. Once the developer is satisfied with the application, the application can be uploaded to an application server. The application developer may “sign” the new application to confirm that it is ready, and may also send some information to the operator to indicate how the application should be marketed or how the operator should charge for its use. When this is done, a message may be sent automatically to the operator's operation and maintenance system, and the operator may then test the application to ensure that it meets standards for, say, quality and decency.

The operator can then make the application available to end-users and can categorize the application according to the operator's own model—for example, according to application type (sports, movie, or news) or functionality (positioning, messaging, or m-commerce). The application is put on a publicly available Application Server and may be marketed in a highly targeted way, e.g., by automatically sending a message to the website or mobile phone of customers whose profiles match the application categories.

In this way, the Service Network enables the operator to have close or loose partnerships with application developers, perhaps giving certain developers special opportunities to test applications live, and to stipulate how use of the applications is to be charged. The Service Network can thus be seen as an IP-based “glue” that binds together different access media, core networks, content and service providers, and end-user devices for seamless service delivery. It advantageously handles any type of service, telecommunications, data communications, Internet, and multimedia services.

As depicted in FIG. 4, the Service Network is a distributed service architecture in which directory services are components for managing network resources. A general-purpose directory service typically has the following functions: naming and locating distributed network resources, administering and managing distributed network resources, enabling applications, and authentication, authorization, and security. Given these general functions of a directory service, the following describes directory service functions for storing and managing end-user profiles in the architecture depicted in FIG. 4.

A common user profile directory (“CUPD”) provides a single point of access to user-related data in the network. Among others, desirable characteristics of the CUPD are that it is a distributed directory, that it contains user profile data, that it is accessible through standard interfaces, that it is administered by operators, applications, and end-users via the PSEM, and that it is robust, secure, and scalable to fit different sized networks and to support increasing numbers of end-users, applications, and access technologies. The CUPD may also contain references to subscribed services for respective end-users.

From FIG. 4, it can be seen that the CUPD plays an important part in PSE management. Data related to an end-user that is accessible through the CUPD can generally be divided into three groups: user profile data, service profile data, and service data.

User profile data is mainly information regarding the characteristics of an end-user such as a telephone system subscriber, that is to say, basic user/subscription data associated with the end-user's PSE profile. For example, user profile data may include personal data (e.g., name, social insurance number, age, sex), one or more logical identifiers (e.g., logical name, personal telephone number(s), e-mail address(es)), authentication data (e.g., password, pin, voiceprint and other biometric data), and service-independent preferences (e.g., preferred language, billing information, biometric data). In addition, user profile data also contains a list of references and searchable keys to all services, which are subscribed to by the end-user.

Service profile data includes information that can be readily changed by the end-user or subscriber, e.g., a call-forwarding number.

Service data includes information that cannot be changed by the end-user, that is to say, data that is set by an application or service. Such service data may define the configuration or set-up of a service.

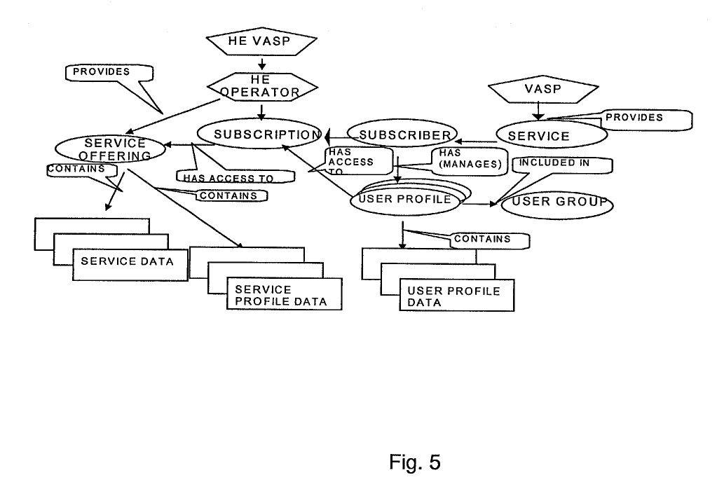

To help understand how the information accessible to a CUPD fits into a telecommunication system, one may refer to FIG. 5, which is an outline of customer data in a UMTS network. In general, value-added service providers (“VASPs”) and network operators maintain user profile data and provide that data to service, subscription, and service offering functionalities, which themselves generally maintain service data. The subscriber has, or manages, its user profile(s), including user profile data, that have access to the subscription functionality and is(are) included in one or more user groups relevant to the subscriber. As indicated in FIG. 5, the subscription functionality has access to the service offering, which also sees user profile data provided by the operator. It will be appreciated that a UMTS network is used only as a specific example; most current communication networks maintain similar information, although it may be organized differently.

As depicted in FIG. 5, the customer data maintained in a service offering and user profile in the UMTS network contains the user profile data that is stored in the CUPD, service profile data that is stored in services/applications, and service data that is stored and managed by the services/applications of the Service Network. This customer data would be extracted for migration from the UMTS or other network to the Service Network.

The PSEM includes functions for providing and managing service data, end-user profile data, and end-user service profile data. It will be appreciated that these functions can be implemented in suitable software that is executed on suitably appropriate hardware. Among others, important aspects of the PSEM are its interfaces to other entities and functions, its distinguishing between user profile data and service-related data (i.e., service profile data and service data), and its further distinguishing between service profile data and service data.

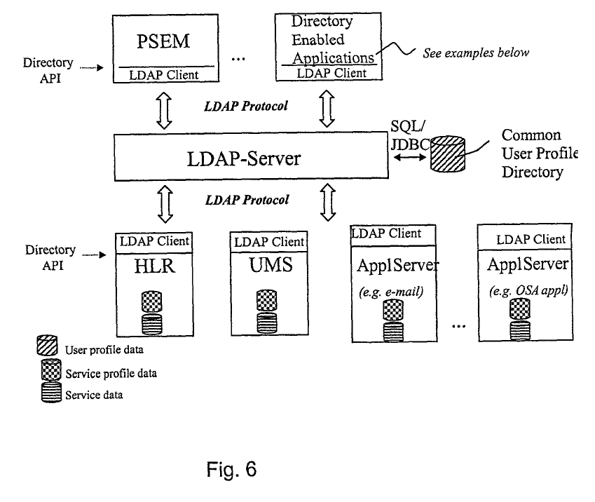

Among the general aspects of data management in accordance with this invention, it is currently believed to be preferable for the CUPD to be accessible through a client/server communication architecture based on the LDAP. In an “ideal” situation, e.g., when no legacy network exists, all user profile data could be accessed via a centralized directory/database as shown in FIG. 6. It will be appreciated that FIG. 6 is similar to FIG. 4 in that it shows the PSE Manager, Applications, and Service Enablers depicted in the latter figure.

As seen in FIG. 6, the HLR and a User Mobility Server (“UMS”), which are SCSs, retain service profile data and service data, as do Application Servers such as email and an OSA application, but user profile data that would have been retained in these devices is centralized in the CUPD. Access to the CUPD can be via a SQL/JDBC interface from an LDAP-Server, which communicates via the LDAP with LDAP clients (protocol translators) and suitable APIs, and therethrough with the PSEM and other functionalities. The UMS typically provides functionality for handling multimedia profiles while the HLR handles telephone-type profiles. It will be recognized that the e-mail and OSA applications illustrated in FIG. 6 are not the only possibilities, as indicated by the block labeled “Directory Enabled Applications”.

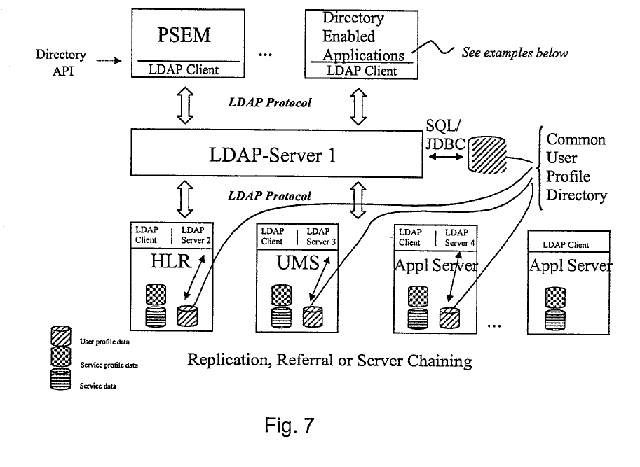

Nevertheless, it may be necessary to migrate from a legacy architecture of a network in which user data is spread over several nodes in the network as suggested above in connection with FIG. 5. In this case, the CUPD/database can be distributed, as shown in FIG. 7, which is to say that there may be more than one directory server that has access to the CUPD. It will be appreciated that FIG. 7 is similar to FIG. 4 in the same manner as FIG. 6 is similar to FIG. 4. The applications and Service Enablers depicted in FIG. 7 are just those depicted in FIG. 6, but their arrangement is slightly different because customer data is arranged in a different way. In particular, the HLR, UMS, and one of the two Application Servers are shown as including LDAP Servers 2-4, with the second Application Server including only an LDAP client as in FIG. 6. It will be noted that the LDAP servers 2-4 are available for accessing user profile data that is retained by the respective HLR, UMS, and Application Server, as depicted by the two-headed arrows. In such an arrangement, the CUPD contains references, pointers, or similar indicators that refer requesting entities, either directly or indirectly, to these user profile data stores. In a sense, of course, the user profile data locally stored in these devices may still be considered as part of the CUPD, as indicated by the lines connecting these devices to the CUPD.

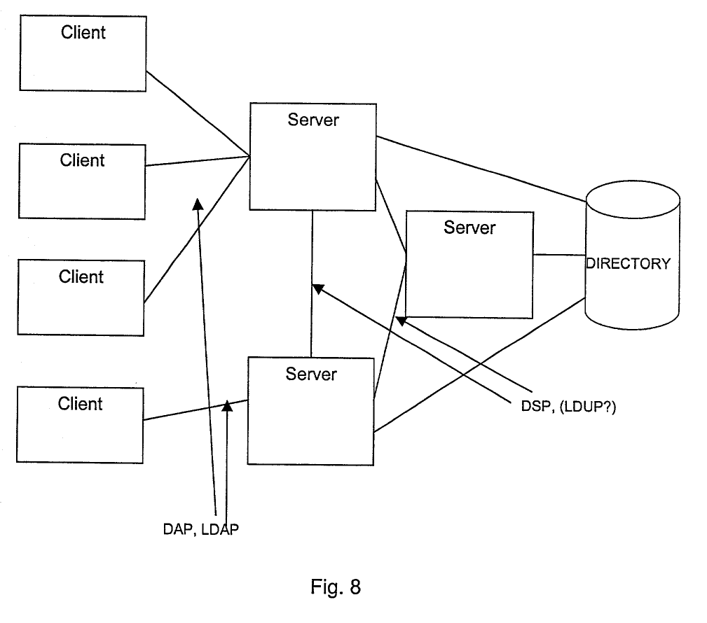

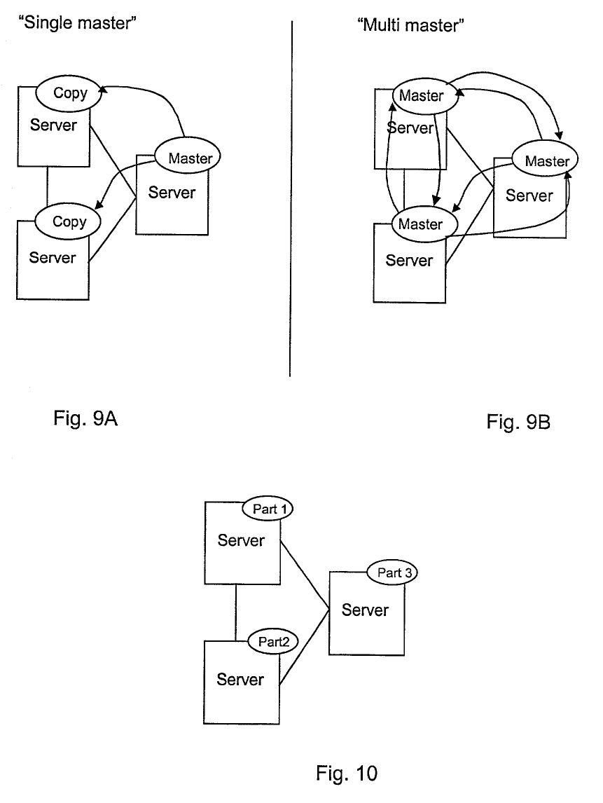

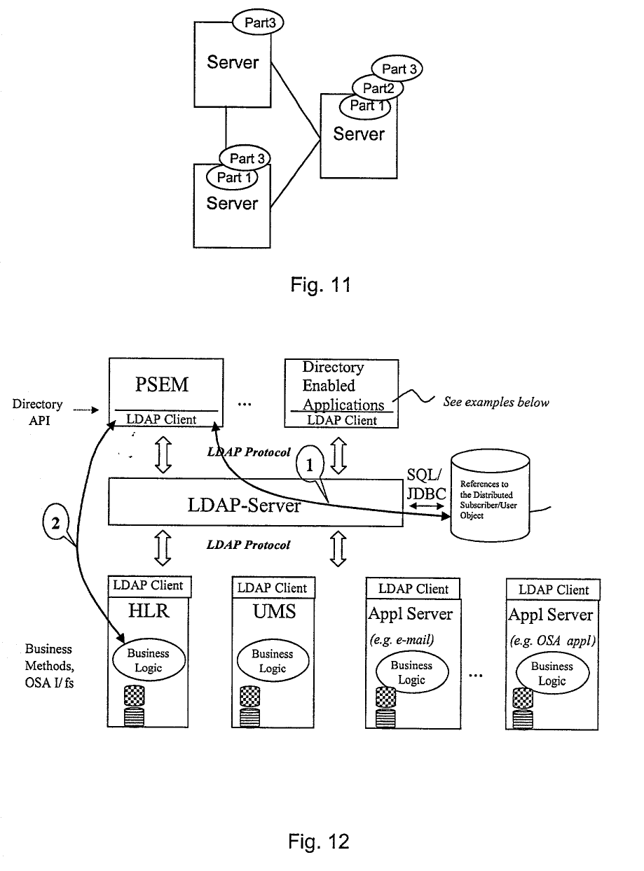

Thus, it will be understood that the CUPD can be either distributed or centralized. If the directory is distributed, there are several directory servers that have access to the directory, and if the directory is centralized, only one directory server has access to the directory. FIG. 8 shows a distributed directory, with communication between three directory servers being conducted via the Directory Update Protocol (“DUP”) or perhaps a Lightweight DUP (“LDUP”). The information in a distributed directory can either be replicated or partitioned or a combination of both. FIG. 9A shows a replicated directory using single master replication in two copies, and FIG. 9B shows a replicated directory using multi master replication. FIG. 10 shows a three-part partitioned directory, and FIG. 11 shows a three-part partitioned and replicated (parts 1 and 3) directory.

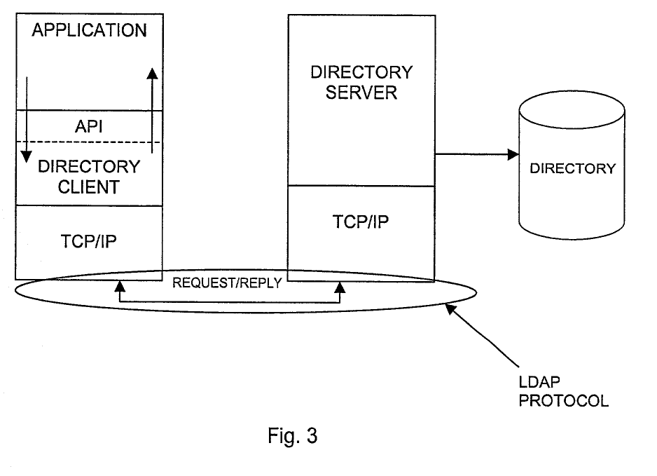

As noted above in connection with FIG. 3, when an application, e.g., an HLR, an e-mail server, or the PSEM, needs to access user profile data that is stored in a distributed directory, a request is sent from the client to LDAP-Server 1 (see FIG. 7), which returns the requested information if it is available in the CUPD. If the information is not available there, LDAP-Server 1 may respond to the request with a referral to another server, and the requesting application may then choose to follow the referral by querying the other server, e.g., LDAP-Server 2, identified in the referral. Again, if the information is not available there, the other server may respond with another referral. Rather than possibly receiving serial referrals, the requested data may be found through server chaining. If LDAP-Server 1 does not find requested information, it may find instead a referral to another server, in which case LDAP-Server 1 forwards the request to the other server. The response to the request can then be returned to the requesting application by the other server, either directly or via LDAP-Server 1.

Applications can access service-related data in a manner that initially is the same as the referrals or server chaining described above for accessing user profile data. As depicted in FIG. 12, an application, e.g., the PSEM, sends a request to LDAP-Server 1, which returns the information, either service profile data or service data, if it is available. This communication is indicated by the two-headed arrow 1. If the information is not available, LDAP-Server 1 returns information that includes an object reference to a distributed subscriber/user object, e.g., an HLR. The application that initiated the request, e.g., the PSEM, can then invoke a method on the requested data in the subscriber/user object (application) where it is stored as represented by the business logics included in the SCSs and Application Servers. This is indicated by the two-headed arrow 2. The business logics represent business methods, OSA interfaces, etc. that are implemented by the respective SCSs and Application Servers. Thus, it will be appreciated that FIG. 12 is similar to FIG. 7 in its use of object references, pointers, or similar indicators that direct requests to information stored outside the CUPD and is also similar to FIG. 6 in its centralization of user profile data.

Since 2G networks already contain much subscriber-related data as suggested above in connection with FIG. 5, it is advantageous for there to be an easy migration path from 2G networks to the service network depicted in FIG. 4. Subscriber-related data in a 2G network can roughly be divided into two categories: data related to the call set-up and the traffic execution processes, and data related to subscription administration and (post-) processing of charging data (for invoicing and billing). Examples of call-setup data, which is mainly stored in the core network, e.g., in the HLRNLR and the Authentication Center (“AUC”), are MSISDN, IMSI, location, authentication data, categories, subscriber status, and services list. Examples of subscription-administration data, which is typically stored in Customer Administration Systems (“CAS”), are name, address, and billing information. A migration strategy for the core network user profile data and for handling user profile data stored in the CAS is described below.

It will be appreciated that the data in the core network of today's 2G systems includes both user profile data and service profile data. As described in this application, it is advantageous to separate the user profile data from the service profile data and to centralize the user profile data into the CUPD. Since it is likely that the user profile data will be initially distributed over several core network nodes, e.g., the HLR and the CUPD, and since the user profile data is preferably accessible through a single point of access, the HLR/AUC will initially interface with the CUPD as described above. In the long term, it is expected that subscriber-related data in the core network will be centralized as much as possible in the CUPD as depicted in FIG. 6. The HLR may hold the service profile data and serve as a “gateway” to the Service Network for accessing user profile data from the CUPD.

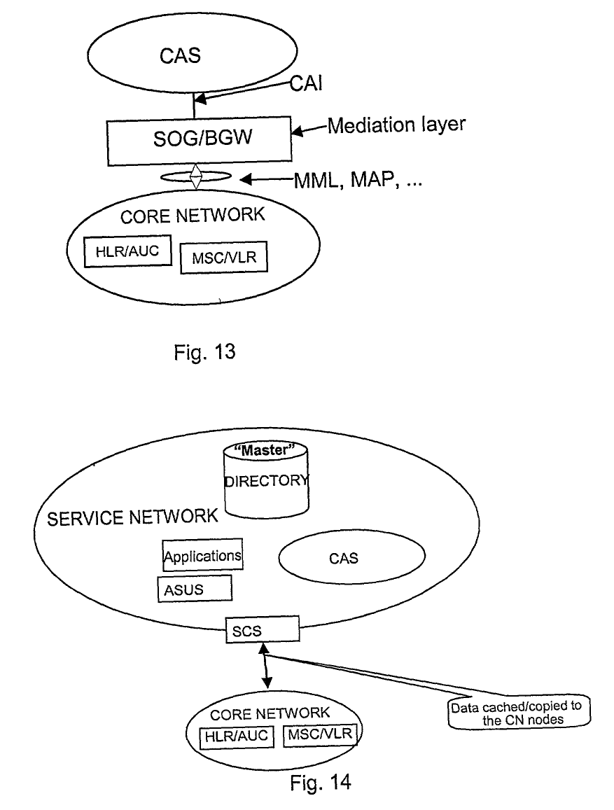

In existing 2G mobile networks, the operator's administrative systems form an important link in the process of service provisioning and billing collection. These systems, often called CAS, are connected to the underlying core network through a mediation layer, e.g., SOG and BGW, as depicted in FIG. 13. The introduction of a Service Network layer and generic data storage outside the core network as described in this application impacts this architecture.

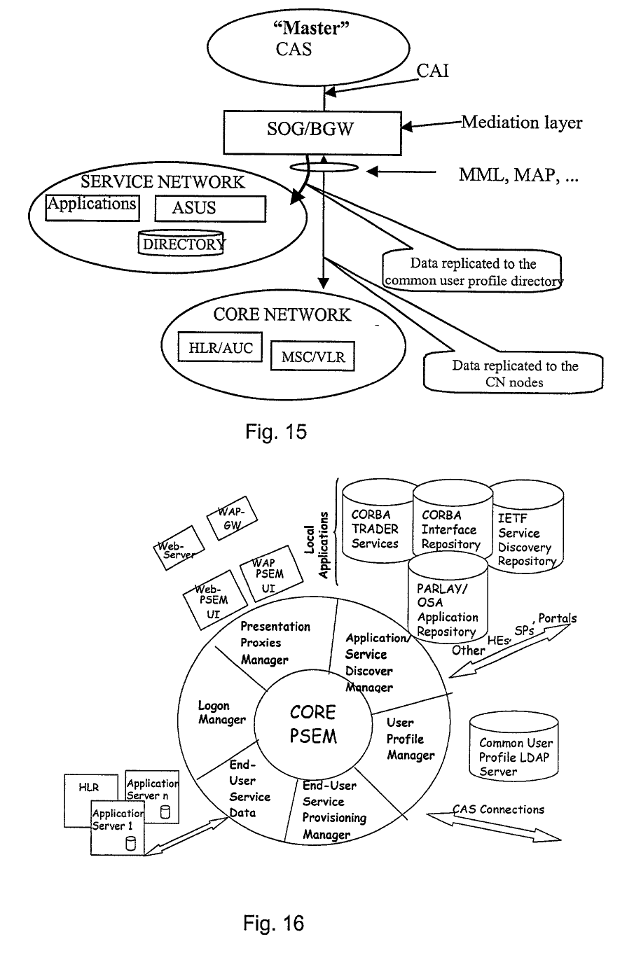

One alternative for distributing user profile data between the CAS and the CUPD in the Service Network is to integrate the CAS and the Service Network as depicted in FIG. 14. The CUPD is the “master” repository, and data in the CAS can be accessed by the applications. Another alternative for distributing user profile data between the CAS and the CUPD in the Service Network is to keep the CAS separate from the core network (“CN”) and Service Network as depicted in FIG. 15. The CAS is the “master” repository (as it is today), and data from the CAS is replicated to the Service Network and its included Applications, ASUSs, and CUPD through the SOG/BGW, as is done today with data from the CAS replicated to the core network in entities such as an HLR/AUC and an MSCNLR. In this way, the SOG/BGW acts as a kind of mediation layer between the CAS and their customer administration interface (“CAI”) and the core and service networks and their interfaces, such as Mobile Markup Language (“MML”) and Mobile Application Protocol (“MAP”).

As described above, an important part of the Service Network is the PSEM, which is a management function for administration by end-users of user profile data and service profile data in the Service Network. Accordingly, the PSEM is not coupled to a specific access type or underlying core network, and is advantageously reachable via several access and core networks as noted above. The PSEM can be part of VHE implementations, portal implementations, ISP implementations, etc. based on the Service Network architecture and can advantageously be customized to fit different needs. The PSEM preferably provides the following functionality: end-user authorization and authentication; end-user interface proxies towards various access devices, e.g., personal computer (“PC”), mobile phone, personal data assistant (“PDA”), etc.; end-user service management, e.g., service discovery, service provisioning, and service customization; end-user access to the CUPD; and access and availability control of applications and services.

The PSEM is advantageously divided into a PSEM core and a number of PSEM managers, such as the arrangement depicted in FIG. 16, which will be recognized as another way of seeing the arrangement depicted in FIG. 4. The PSEM core governs the managers and is the co-ordinator that regulates the framework in which the PSEM managers are part.

A Logon Manager handles the logon procedures that enable an end-user to access the user's PSE. The Logon Manager is also preferably responsible for coordination of an end-user's “first time registration” and set-up of the user's PSEM profile as well as for subsequent logons, including authentication and authorization of the end-user. Among other things, the Logon Manager may also automatically perform authorization procedures towards Application Servers either in the Service Network or at Application/Content Providers, Home Environment Value Added Service Providers (“HE-VASP”) Service Networks, when a user chooses to access these.

An End-User Service Provisioning Manager administers the provision of services to the end-user based, for example, on a user-group that the user belongs to. Services may be presented to the end-user as service packages or as separate services. Available services/applications are based on information gathered from an Application/Service Discovery Manager.

A User Profile Manager is responsible for managing (e.g., inserting, deleting, modifying, reading, etc.) the user profile data towards a common directory/database architecture (e.g., an LDAP server). The User Profile Manager may advantageously implement the VHE, with Parlay User Profile requirements and User Profile service capability features. The User Profile Manager also provides an interface to CAS.

A Presentation Proxies Manager provides the PSEM user interface towards the end-user. For example, the Presentation Proxies Manager provides User Interface Proxies, such as WAP and World-wide Web user interfaces, towards the PSEM services. The end-user can thus access the PSEM from various device types, e.g., PC, mobile and other phones, PDA, game playstations, set-top cable television boxes, etc., through Web-servers, WAP gateways, etc. The Presentation Proxies Manager communicates with the PSEM core and the other managers to implement the services it offers to the Presentation Proxies.

An Application/Service Discovery Manager handles discovery of applications and services by interfacing to local applications that may include a Parlay/OSA application framework or repository, common object request broker architecture (“CORBA”) Trader services and interface repositories, and Internet Engineering Task Force (“IETF”) service discovery repositories, as well as other home environments (“HEs”), service providers, portals, etc. It receives “registrations” from applications/services towards the PSEM and provides information about available services to the Presentation Proxies Manager and the End-User Service Provisioning Manager.

An End-User Service Data Manager handles end-user service data towards applications (servers) in other systems, e.g., the HLR. It handles changes to service-specific data, that is to say, not user profile data (which is handled by the User Profile Manager), when the PSEM is used in a Proxy Mode, which is described in more detail below.

The PSEM can be used by applications as a proxy for reading/writing user profile data and/or service profile data, considerably simplifying the operations of the applications. The PSEM presents a distributed user object as a centralized user object that is accessed in a homogeneous way, thereby hiding complexities of data distribution and heterogeneous access methods to data sources (e.g., databases and directories) from the applications.

It will be appreciated that although six distinct managers have been described in connection with the PSEM, it is not necessary for the PSEM to be organized in this way. It is sufficient for the functionality provided by these kinds of managers to be provided by the PSEM.

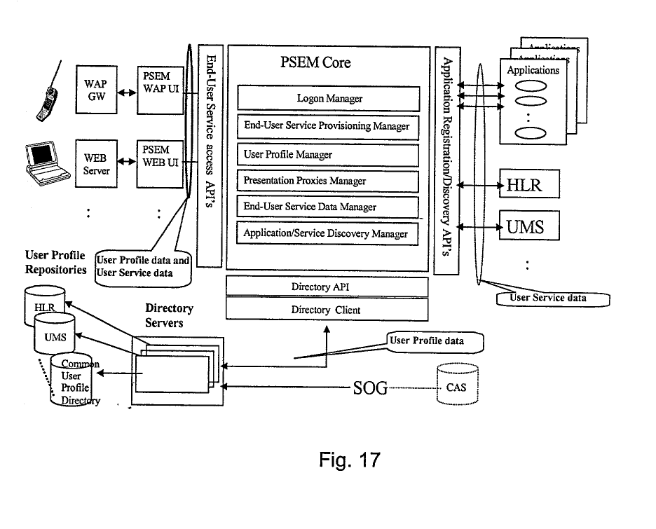

FIG. 17 depicts how user profile data and service profile data, respectively, are accessed and managed in the PSEM architecture, and it will be recognized that FIG. 17 is another way of seeing the arrangements depicted in FIGS. 4 and 16 that highlights the data flows handled by the PSEM and its included Managers. As noted above, one of the important aspects of the PSEM is its interfaces to other entities, and it can be seen from FIG. 17 that these interfaces are mediated by end-user service access APIs toward WAP gateways, Web servers, etc. for user profile data and service data; by application registration/discovery APIs toward applications and service enablers like an HLR and a UMS for service data; and by a directory API(s) toward repositories of user profile data. As described above, user profile data may be centralized in a CUPD or distributed among repositories like an HLR and a UMS as well as a CUPD. It will be appreciated that much user profile data may be created by other entities, such as an operator's CAS that may provide the data to the repositories through a SOG as indicated in FIG. 17. Indeed, an operator may maintain customer data like user profile data in an administrative database that is duplicates as appropriate or desired in entities like an HLR.

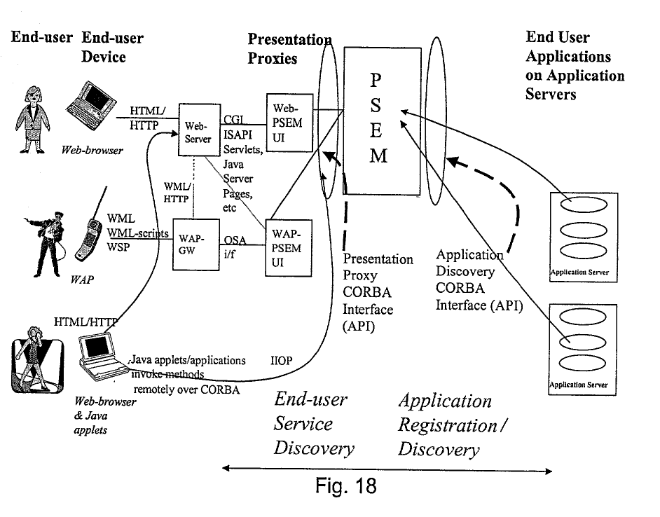

FIG. 18 depicts how end-users with different types of end-user devices and user interfaces are connected to the PSEM. Like FIG. 17, it will be recognized that FIG. 18 is another way of seeing the arrangements depicted in FIGS. 4, 16, and 17 that highlights interfaces for end-user service discovery/service provisioning as an example. The PSEM is simplified in FIG. 18 in that the different internal Managers are not shown, although the figure does show interfaces to the end-user that are handled by the Presentation Proxies Manager and a suitable API, such as a CORBA interface, and that presents a WAP user interface and a Web user interface. The Web user interface may communicate with a Web Server, presenting CGI ISAPI Servlets, Java Server Pages, and other applications and applets, that an end-user can select via a Web browser that communicates with the Web server via a markup language and communication protocol such as HTML and HTTP. The WAP user interface may communicate with a WAP gateway via an OSA interface, with the WAP gateway receiving wireless markup language (“WML”) commands and scripts from an end-user. FIG. 18 also shows a Web browser and Java applets that can communicate with the Presentation Proxies Manager and invoke methods remotely via HTML/HTTP through the Web server or directly via a protocol such as the Internet inter-ORB Protocol (“IIOP”). These interfaces are used in the course of end-user service discovery, as indicated by the left-hand portion of the two-headed horizontal arrow in FIG. 18.

The application registration/discovery aspects of end-user service discovery/service provisioning as depicted in FIG. 18 advantageously can use a CORBA interface (API) for communication between the PSEM and end-user available applications on Application Servers. This is indicated by the right-hand portion of the two-headed horizontal arrow in FIG. 18.

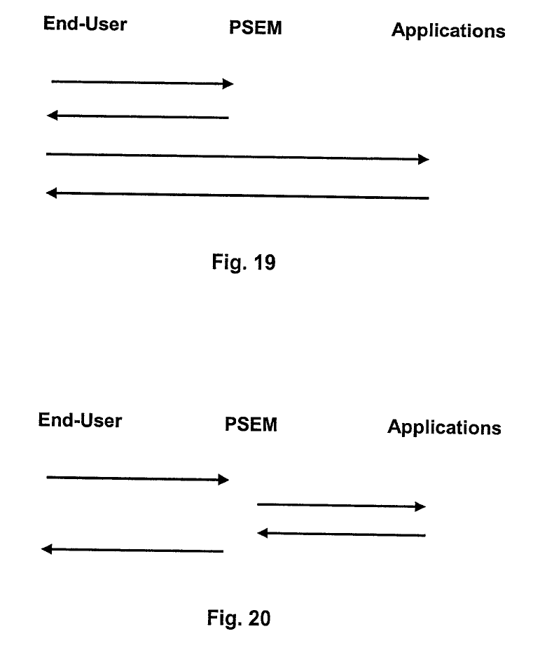

The PSEM can work in two modes towards Application Servers for service profile data personalization (management). A “broker mode” is suitable when an Application Server implements end-user service management functionality and user interfaces such as WAP and/or Web. In broker mode, the PSEM hands over control to the Application when an end-user chooses to change service profile data for a particular service. This is depicted in FIG. 19.

Broker mode may be used for many applications, but it could also have some drawbacks. For example, to maintain the same “look and feel” for the management of applications of the PSE, it is necessary to implement user interfaces for service management for several different device types in all applications, to implement changes to all applications when support for a new user interface is introduced, etc. The implementation effort may be too onerous.

This can be avoided by using the PSEM in a “proxy mode”, which is depicted in FIG. 20. A prerequisite for the proxy mode is that an application's service management interface is known, but this is already a requirement on tightly coupled applications.

Several typical use cases are described below to illustrate handling subscriber related data in a UMTS network in accordance with the PSEM.

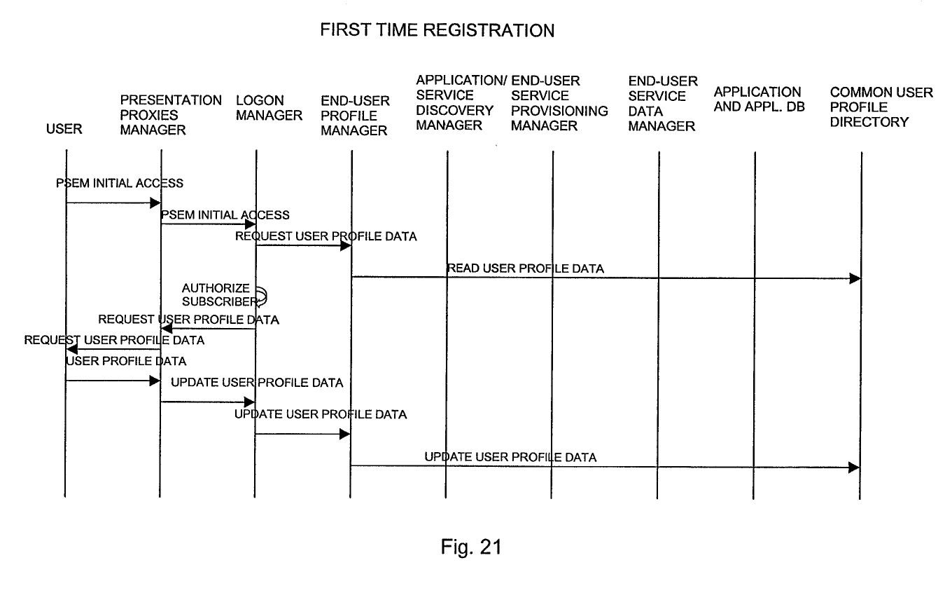

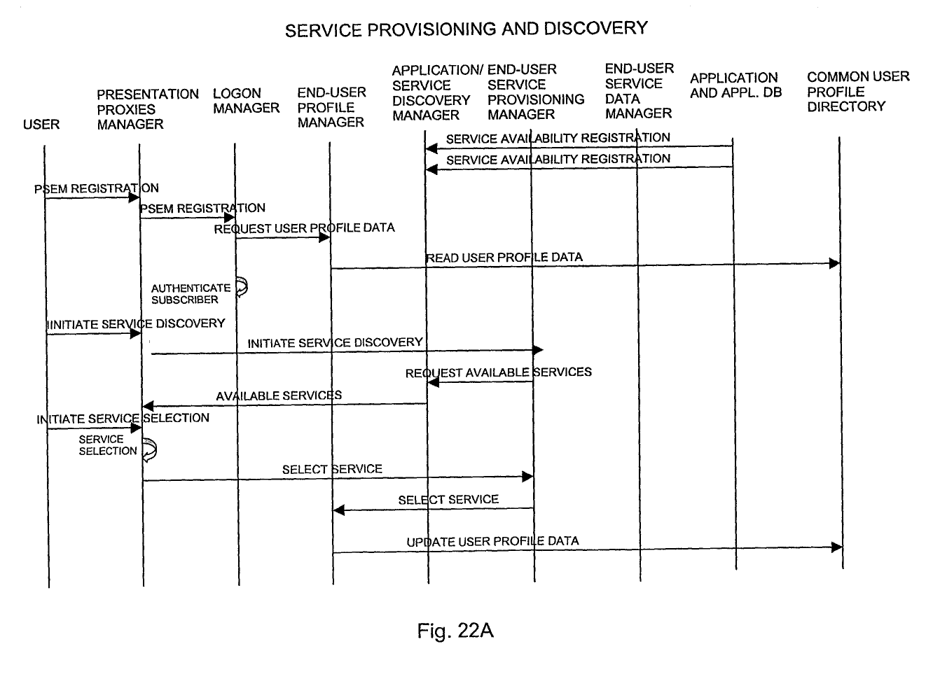

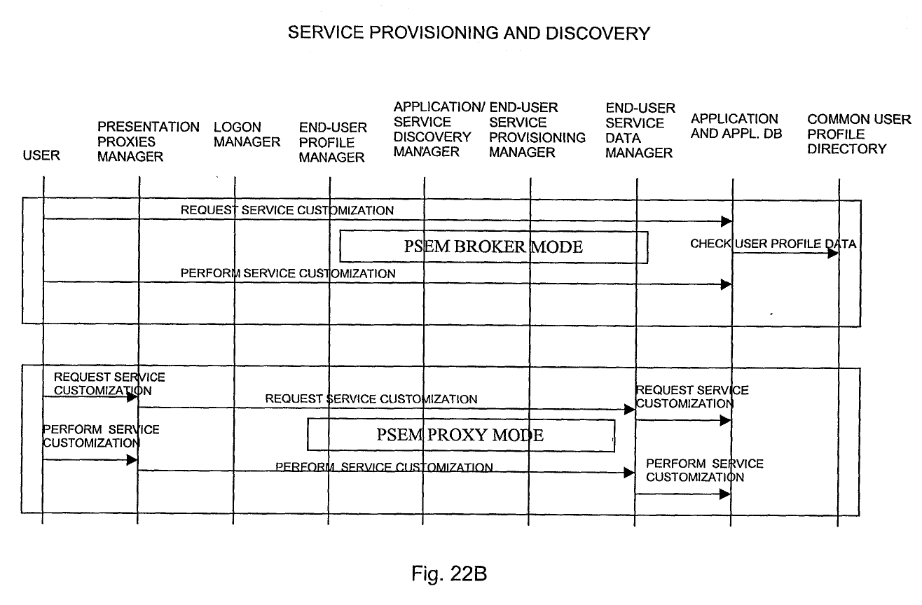

As depicted in FIG. 21, during a “first time registration”, an end-user makes an initial access to the PSEM, in particular to the Presentation Proxies Manager component of the PSEM, which forwards the access attempt to the Logon Manager. The Logon Manager initially authenticates and authorizes the end-user, and sends a request to the end-user via the Presentation Proxies Manager for user profile data. The Logon Manager may also direct the request for user profile data to the CUPD, which of course will find that no information is available for a first-time registering end-user. The end-user responds to the request with user profile data, which is passed to the End-User Profile Manager that forwards the data to the CUPD, which would typically respond with an acknowledgment message (not shown).

It may be noted that the end-user does not interface directly with the Logon Manager in the flow chart depicted in FIG. 21, but it will be understood that the functionality used by the Presentation Proxies Manager for the end-user's first-time registration may be distributed to the Logon Manager. The division of the PSEM into different managers having respective functionalities that is described in this application can be viewed as a logical split; functional implementations of this split can vary.

FIGS. 22A, 22B depict service provisioning and discovery. Referring to FIG. 22A, an application and/or an application database sends a “Service Availability Registration” message to the Application/Service Discovery Manager in order to make the service “visible”, or available, to the end-user. The End-User Service Provisioning Manager governs whether an application or service is available to an end-user based on the end-user's profile settings, which are found in the CUPD. Some services may not be visible to the end-user depending on that end-user's profile settings. The Logon Manager sends a request for this end-user's profile data to the End-User Profile Manager and the CUPD. If authenticated, the end-user can access the end-user's “services home page” that is customized based on the end-user's profile data, enabling the end-user to “browse” through the applications and services that are available to that end-user.

An end-user seeking an application or service “registers” via the Presentation Proxies Manager with the Logon Manager, through a WAP gateway, for example, by entering a password/pin code and perhaps a user name, thereby initiating service discovery. An “Initiate Service Discovery” message is presented to the Presentation Proxies Manager, which passes the message to the End-User Service Provisioning Manager. The End-User Service Provisioning Manager queries the Application/Service Discovery Manager, which replies to the Presentation Proxies Manager with a list or other identification of the applications and services available to this end-user.

If the end-user selects an application or service, a “Select Service Request” message is sent to the End-User Service Provisioning Manager, which sends a “Select Service” message to the End-User Profile Manager. The end-user's User Profile Data will be updated with information regarding the selected service by an “Update User Profile Data” message sent to the CUPD. When the Select Service Request message has been accepted, the CUPD will return an acknowledgment containing a link to the appropriate Application Server (e.g., a URL for WAP and WWW). It will be noted that acknowledgment messages are not shown in FIG. 21, 22A, and 22B for clarity.

The end-user may now configure the application/service (personalization) in the Application Server. As noted above, the PSEM can work in either broker or proxy modes towards Application Servers for service profile data personalization (management). This is depicted in FIG. 22B, which shows that the end-user sends a “Request Service Customization” message to the application and application database, either directly (broker mode) or indirectly (proxy mode). In response in broker mode, the application checks the end-user's profile data in the CUPD and sends a “Service Profile Update” message to the service profile database in the CUPD in order to configure the service according to the end-user's request. Finally, the service/application returns an acknowledgment to the end-user to confirm that the service/application has been configured.

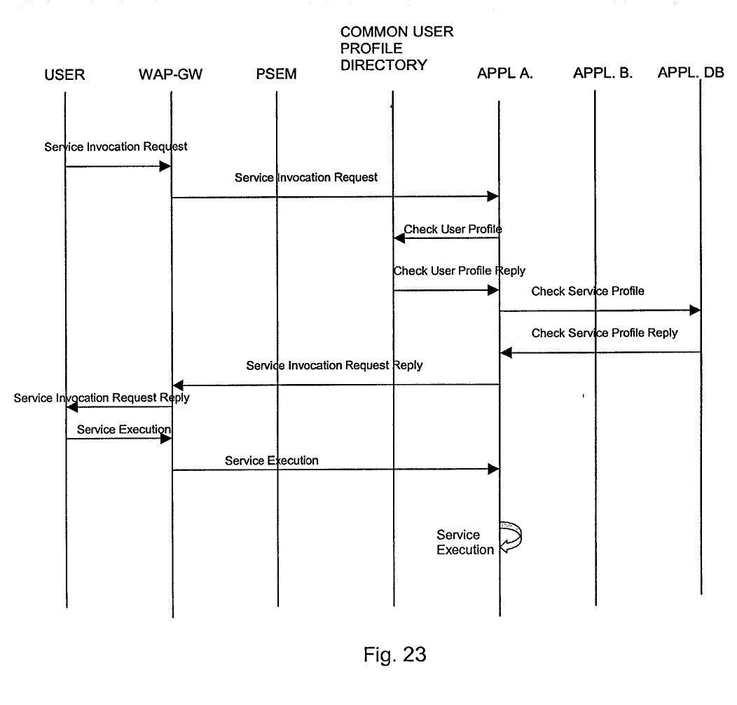

FIG. 23 depicts service execution in a Mobile Execution Environment with SCSs, with a WAP gateway as an SCS. As shown in FIG. 23, the end user invokes a service by sending a “Service Invocation Request” message to the Service Network through, for example, the WAP gateway, which passes the Request directly towards the application. The application verifies that the user subscribes to the requested service by sending a “Check User Profile” message to the CUPD, which replies with the appropriate information. The application then checks the end-user's service preferences by sending a “Check Service Profile” message to a service profile database, which replies with the appropriate information. When the requested service has been successfully invoked, i.e., the application replies to the Service Invocation Request by sending a reply message to the WAP gateway and end-user, the end-user may initiate service execution by sending a “Service Execution Request” message through the WAP gateway to the application.

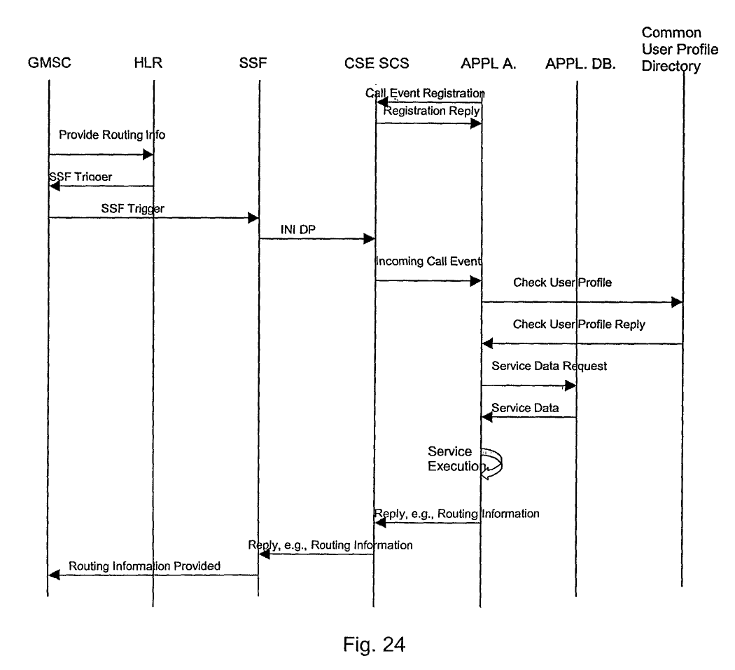

FIG. 24 depicts service execution in a CAMEL service environment (“CSE”) with SCSs, which may be called “call control”. As shown in FIG. 24, an application sends a “Call Event Registration” message to a CSE SCS in order to subscribe to a call event for a specific end-user, and the CSE SCS sends and acknowledging reply message. During call set-up, if the HLR detects a “service” trigger, the gateway MSC routes the call to the SSF, which interrogates the CSE SCS for instructions about how to route the call. The CSE SCS sends an “Incoming Call Event” message to the application with information about the subscribed call event for the specific end-user. The application verifies that the end-user subscribes to the requested service by sending a “Check User Profile” message to the CUPD, which replies with the appropriate information. The application then checks the service profile data by sending a “Service Data Request” message to a service profile database, which replies with the appropriate service data. The service then executes in the application, which returns routing information, for example, to the CSE SCS, which passes the information back to the gateway MSC.

As described above, one of the advantages of the PSEM is that it enables personalization of applications in application servers. This form of service provisioning, like the processes depicted in FIGS. 21, 22A, 22B, can be carried out in either broker mode or proxy mode.

In either broker or proxy mode, the end-user accesses the Presentation Proxies Manager, which in turn requests the End-User Service Provisioning Manager to obtain information via the Application/Service Discovery Manager from the CUPD that identifies the services available to the end-user. The End-User Service Provisioning Manager may sort the retrieved information based on the end-user's subscription rules, e.g., which user group(s) the end-user belongs to, and that information is presented by the Provisioning Manager to the end-user through the Presentation Proxies Manager. As an alternative, the Provisioning Manager may request the User Profile Manager to fetch information identifying already-subscribed-to services from the CUPD. If the end-user wishes to subscribe to a new service, the User Profile Manager is requested through the Presentation Proxies Manager to add the desired service to a list or other record of subscribed-to services in the CUPD. The CUPD acknowledges the addition with a suitable message that passes to the end-user through the User Profile Manager and the Presentation Proxies Manager, the acknowledgment including a link or other indication for the end-user to use in accessing the application server hosting the desired service. The CUPD may also store an identifier or key in association with the end-user's user profile data that enables the application to verify that the end-user has subscribed to the service.

In broker mode, the end-user can finish personalizing the service by accessing the application server and providing service-specific data that may be stored in a database used by the application server. In proxy mode, the End-User Service Data Manager stands between the end-user's terminal and the application server, informing the application server that the end-user has been included in the CUPD and how to find the end-user in that directory, i.e., identifying the end-user's identifier or key. Common user data can then be “filled in” by the End-User Service Data Manager or read by the application server as in broker mode, with service-specific data being stored in a database used by the application server.

It will be understood that the foregoing messages are illustrative and each can be replaced with one or more “sub-messages” that together yield the described effect.

It will also be understood that X.500 directories can be distributed among servers called Directory System Agents (“DSA”). A DSA is basically a database, in which information is stored in a structure according to the X.500 information model. Replication can be used to synchronize the information between DSAs through use of the Directory System Protocol (“DSP”) of X.500. All DSAs in an X.500 Directory Service are interconnected according to a predefined model called a Directory Information Tree (“DIT”). The DIT is a virtual hierarchical data structure and is a representation of the global Directory. The standard does not describe how to distribute different parts of the Directory amongst DSAs, although the distribution is totally transparent to the users of the Directory.

A user of the Directory can be a person or a computer. A user accesses the Directory through a Directory User Agent (“DUA”) that automatically contacts a nearby DSA through which the user can search or browse through the DIT and retrieve corresponding information. In the case of the Directory Service, the protocol used by a DUA to relay a request to a DSA is the DAP.

LDAP has several advantages over DAP. LDAP runs directly over the TCP, eliminating much of the connection set-up and packet-handling overhead of the OSI session and presentation layers required by DAP. LDAP simplifies the X.500 functional model in two ways. It leaves out the read and list operations, emulating them via the search operation. It also leaves out some less-often-used service controls and security features of full X.500, which simplifies LDAP implementations. LDAP encodes its protocol elements in a less complex way than DAP, streamlining coding/decoding of requests. LDAP automatically handles the referrals returned by X.500. The LDAP server is responsible for chasing down any referrals returned by X.500, and therefore LDAP returns only either a result or an error to the client. This makes a network of servers appear as one single logical directory.

Various embodiments of Applicants' invention have been described above, and it is expected that the embodiments described above can be modified by those of ordinary skill in the art. Accordingly, it will be understood that Applicants' invention is not limited to these embodiments but is defined by the following claims and is intended to include all modifications that fall within the scopes of these claims.

What is claimed is:

1. A personal service environment manager (“PSEM”) for managing information relating to end-users of a communication network that includes at least one application server for providing at least one network service, the information including end-user profile data and service-related data, the PSEM comprising a PSEM core and a plurality of PSEM managers, wherein the PSEM core governs the managers for providing end-user authorization and authentication in the communication network, end-user interface proxies towards communication access devices, end-user service management, including service discovery, service provisioning, and service customization, and access and availability control of the at least one application server.

2. The PSEM of claim 1, wherein the managers include a Logon Manager that handles the logon procedures enabling an end-user to access information relating to the end-user; an End-User Service Provisioning Manager that administers provision of services to end-users; a User Profile Manager that inserts, deletes, modifies, and reads end-user profile data in a common directory; a Presentation Proxies Manager that provides adjustable user interfaces to end-users; an Application/Service Discovery Manager that handles discovery of applications and services by interfacing to the at least one application server; and an End-User Service Data Manager that handles service-related data.

3. The PSEM of claim 2, wherein the Application/Service Discovery Manager receives registrations from applications and services sent to the PSEM and provides information about available services to the Presentation Proxies Manager and the End-User Service Provisioning Manager.

4. The PSEM of claim 3, wherein services and applications are available to an end-user based on information gathered from the Application/Service Discovery Manager.

5. The PSEM of claim 2, wherein the Presentation Proxies Manager provides WAP and World-wide Web user interfaces to end-users for PSEM services and communicates with the PSEM core and the other managers to implement the user interfaces.

6. The PSEM of claim 2, wherein the PSEM can work in either a broker mode or a proxy mode toward an application server for service-related data management.

7. The PSEM of claim 6, wherein in broker mode, the PSEM hands over control to the application server when an end-user changes service-related data, and in proxy mode, the PSEM controls the application server when the end-user changes service-related data.

8. The PSEM of claim 7, wherein in both broker and proxy modes, the end-user accesses the Presentation Proxies Manager, which requests the End-User Service Provisioning Manager to obtain information via the Application/Service Discovery Manager from the common directory that identifies services available to the end-user, and that information is presented by the Provisioning Manager to the end-user through the Presentation Proxies Manager.

9. The PSEM of claim 7, wherein in both broker and proxy modes, the end-user accesses the Presentation Proxies Manager, which communicates with the End-User Service Provisioning Manager that requests the User Profile Manager to fetch information identifying already-subscribed-to services from the common directory.

10. The PSEM of claim 8, wherein if the end-user wishes to subscribe to a new service, the User Profile Manager is requested through the Presentation Proxies Manager to add the new service to a list of subscribed-to services in the common directory, and an indication is passed to the end-user to use in accessing the application server hosting the new service.

11. The PSEM of claim 10, wherein the common directory includes an identifier in association with the end-user's user profile data that enables an application to verify that the end-user has subscribed to a service provided by the application.

12. The PSEM of claim 2, wherein the common directory includes end-user profile data and is either distributed or centralized.

13. The PSEM of claim 12, wherein the service-related data includes service profile data and service data, service profile data includes information changeable by end-users, and service data includes information that is set by applications and defines configuration of services provided by the service network.

14. The PSEM of claim 13, wherein end-user profile data includes information relating to predetermined characteristics of an end-user.

15. The PSEM of claim 14, wherein end-user profile data includes personal data, at least one logical identifier of a respective end-user, authentication data, and service-independent preferences.

16. The PSEM of claim 15, wherein end-user profile data includes a searchable list of references to services subscribed to by respective end-users.

17. A service network, comprising:
at least one application server for providing a respective service to end-users,
a personal service environment manager (“PSEM”) that can exchange information with the at least one application server,
a common user profile directory that is accessible to the personal service environment manager, and
at least one service enabler in communication with the personal service environment manager;
wherein the PSEM mediates end-user authorization and authentication in the service network, end-user interface proxies towards service network access devices, end-user service management, including service discovery, service provisioning, and service customization, end-user access to the common user profile directory, and access and availability control of the at least one application server.

18. The service network of claim 17, wherein the PSEM manages information relating to end-users, the information including end-user profile data and service-related data.

19. The service network of claim 18, wherein the service-related data includes service profile data and service data, service profile data includes information changeable by end-users, and service data includes information that is set by applications and defines configuration of services provided by the service network.

20. The service network of claim 19, wherein end-user profile data is accessible through the common user profile directory and includes information relating to predetermined characteristics of an end-user.

21. The service network of claim 20, wherein end-user profile data includes personal data, at least one logical identifier of a respective end-user, authentication data, and service-independent preferences.

22. The service network of claim 21, wherein end-user profile data includes a searchable list of references to services subscribed to by respective end-users.

23. The service network of claim 19, wherein the PSEM is used by an application as a proxy for reading/writing end-user profile data in a database accessible to the application.
